(19) United States
(12) Patent Application Publication
(10) Pub. No.: US 2010/0140285 A1
(43) Pub. Date: Jun. 10, 2010

(54) AIRTIGHT CONTAINER AND MOLD FOR PRESS-FORMING THE AIRTIGHT CONTAINER

(75) Inventor: Byung Il CHOI, Incheon (KR)

Correspondence Address: Charles N. J. Ruggiero;Ohlandt, Greeley, Ruggiero & Perle, L.L.P., One Landmark Square, 10th Floor, Stamford, CT, 06901-2682, US

(73) Assignee: Sam Kwang Glass Ind. Co., Ltd.

(21) Appl. No.: 12/401,117

(22) Filed: Mar. 10, 2009

(30) Foreign Application Priority Data
Dec. 4, 2008 (KR) 10-2008-0122415

(51) Int. Cl. B65D 41/02; B65D 45/22; B29C 33/00; B29C 43/36

(52) U.S. Cl. 220/822; 220/833; 220/837; 220/849; 249/119; 249/121

(57) ABSTRACT

Disclosed is an airtight container comprising: a container body having an opening portion and a flange formed along an outer circumference of the opening portion; and a lockable lid that is disposed to cover the opening portion of the container body and that has a locking wing at an edge, wherein the locking wing further comprises upper and lower supporting protrusions disposed on an inner surface of the locking wing at an interval that permits engagement of the flange between the upper and lower supporting protrusions.

### CROSS-REFERENCE TO RELATED APPLICATIONS

This application claims the benefit under 35 U.S.C. § 119 of Korean Patent Application No. 10-2008-0122415, filed on Dec. 4, 2008, the contents of which in their entirety are herein incorporated by reference.

### BACKGROUND OF THE INVENTION

1. Field of the Invention

This disclosure relates to a receptacle (container, vessel, jar, cup, and the like, hereinafter, referred to as “airtight container”) to which a lid is fastened in a lockable type and a mold for press-forming the airtight container.

2. Description of the Related Art

FIG. 1 is a sectional view illustrating an existing airtight container 14 having a container body 10 and a screw lid 12 which is fastened to the body 10.

As illustrated in FIG. 1, in general, on the container body 10 to which the screw lid 12 is fastened, a spiral line 18 is formed along the outer circumference of an opening portion 16 of the container body 10. In addition, a spiral line 20 which is engaged with the spiral line 18 is formed along the inner peripheral surface of the lid 12. The lid 12 and the container body 10 employ an opening and closing structure in which the lid 12 and the container body 10 are fastened to or released from each other as the spiral lines 18 and 20 are engaged or disengaged.

However, in the screw opening and closing structure, in order for the lid 12 to be fastened to or removed from the container body 10, the lid 12 has to be rotated continuously. To do so, a lot of finger movement and manual effort are needed for a user. Therefore, it is annoying and takes time to open and close.

In addition, when the lid 12 is screwed tight on the container body 12 to prevent leakage, it is not easy to rotate the lid 12 to open it, and there is a problem in that it is difficult to open the container body 10.

When the user exerts too much force in order to open the screw lid 12 that is screwed tight, pain and damage may be may be applied to the wrist of the user, and the pain makes the user feel inconvenient. Thus, for the users with weak muscle or grasping power, for example, women, the weak and the aged, it is very difficult to open the screw lid 12.

### BRIEF SUMMARY OF THE INVENTION

The disclosure provides an airtight container having a container body of which an opening portion can be easily opened and closed with a small force while maintaining convenience and promptness of the airtight container having a type in which a lid is screwed on the container body, in order to solve problems of the screw-type opening and closing structure.

The disclosure also provides a mold for press-forming the airtight container.

In one aspect, there is provided an airtight container including: a container body having an opening portion and a flange formed along an outer circumference of the opening portion; and a lockable lid that is disposed to cover the opening portion of the container body and that has a locking wing at an edge, wherein the locking wing further comprises upper and lower supporting protrusions disposed on an inner surface of the locking wing at an interval that permits engagement of the flange is engaged between the upper and lower supporting protrusions.

A convex protrusion may be formed at an end portion of the upper supporting protrusion to engage an upper surface of the upper supporting protrusion, and the convex protrusion may comprise a surface that is curved toward the lower supporting protrusion.

In addition, an outer surface of the convex protrusion may be formed as a curved surface, and a concave groove having an arc-shape may be formed at an upper surface of the flange to be in contact with and to be engaged with the curved outer surface of the convex protrusion.

In another aspect, there is provided a mold for press-forming an airtight container including: a first mold that is formed vertically to press-form a flange having upper area and an opening portion; a second mold that is disposed outside the first mold to press-form a lower area of the flange; and a third mold that is disposed under the second mold to press-form a container body lower area below the flange, wherein the first mold further comprises a convex protrusion protruding downward at a press-formed portion of the first mold corresponding to a spot where the flange opening portion and a root of the flange meet each other and wherein the flange upper area further comprises a groove press-formed by the convex protrusion during the press-forming.

Accordingly, in the airtight container, closing the container body tight by fastening the lid or opening the container body becomes easy while maintaining convenience and promptness of the airtight container of which the lid is screwed on the container body to open and close. In addition, there is an advantage in that a smaller force is required to open and close the lid.

### BRIEF DESCRIPTION OF THE SEVERAL VIEWS OF THE DRAWINGS

The above and other aspects, features and advantages of the disclosed exemplary embodiments will be more apparent from the following detailed description taken in conjunction with the accompanying drawings in which:

FIG. 1 is a sectional view illustrating an existing airtight container having a container body and a screw lid which is fastened to the body;

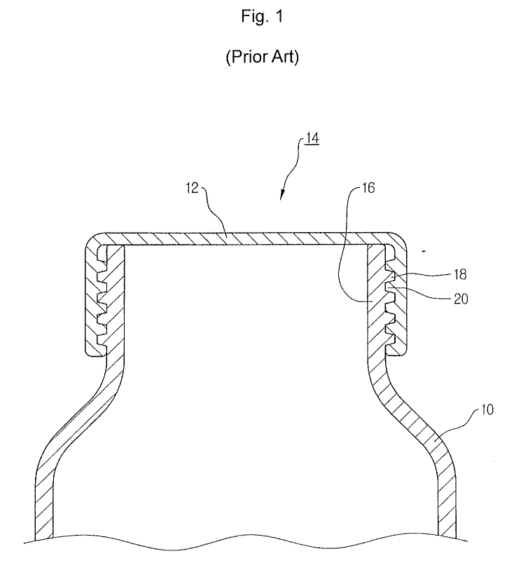

FIG. 2 is a perspective view illustrating an airtight container according to an embodiment;

FIG. 3 is a partial sectional view taken along line I-I of FIG. 2, which illustrates a lockable lid in a locking procedure;

FIG. 4 is a sectional view illustrating a mold according to an embodiment for press-forming the container body; and

FIG. 5 is an enlarged view illustrating a portion of FIG. 4.

### DETAILED DESCRIPTION OF THE INVENTION

Hereinafter, an airtight container and a mold for press-forming the airtight container according to embodiments now will be described more fully with reference to the attached drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

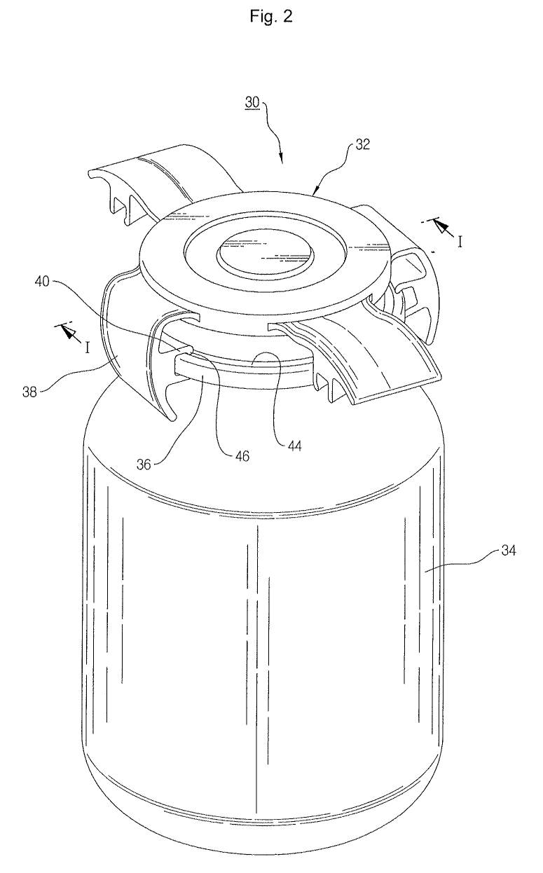

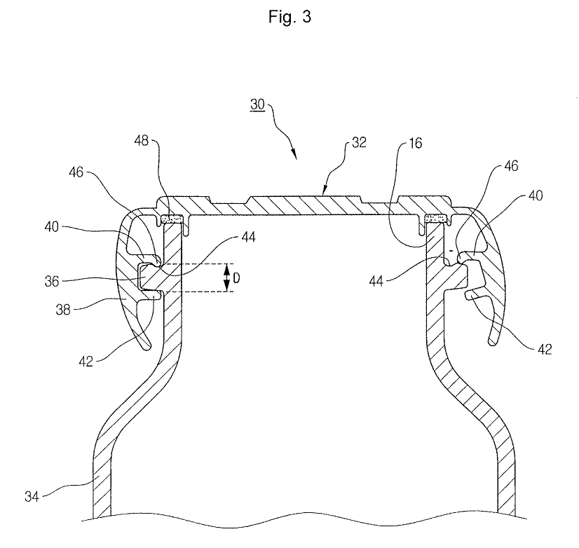

FIG. 2 is a perspective view illustrating the airtight container 30 according to the embodiment. FIG. 3 is a partial sectional view taken along line I-I of FIG. 2, which illustrates a lockable lid 32 in a locking procedure.

As illustrated in FIGS. 2 and 3, the airtight container 30 of the embodiment includes a container body 34 and the lockable lid 32 which covers the upper surface of an opening portion 16 of the container body 34.

A flange 36 is formed along the outer circumference of the opening portion 16 so that the container body 34 is locked with the lockable lid 32. The lockable lid 32 includes locking wings 38 rotatably extending from the edge, and upper and lower supporting protrusions 40 and 42 which are fixed to the inner surface of the end portion of each locking wing 38 to be disposed at an interval D in the width direction.

According to the embodiment, on the upper surface of the flange 36, an arc-shaped concave groove 44 is formed. In addition, an arc-shaped convex protrusion 46 is formed at the end of the upper supporting protrusion 40 which is to be engaged with the concave groove 44. The convex protrusion 46 is curved and inclined with respect to a direction toward the lower supporting protrusion 42.

In FIG. 3, a reference numeral 48 denotes a sealing packing.

According to the embodiment, as described above, the inner surface of the concave groove 44 and the outer surface of the convex protrusion 46 are “arc-shaped” curved surfaces, but not limited thereto. The inner and outer surfaces of the concave groove 44 and the convex protrusion 46, respectively, may be formed to have any shape to be smooth curved surfaces such that the concave groove 44 accommodates the convex protrusion 46 and the convex protrusion 46 can be smoothly released from the concave groove 44.

In addition, as described above, the convex protrusion 46 is curved in the direction toward the lower supporting protrusion 42, but not limited thereto. As long as the convex protrusion 46 presses the upper surface of the flange 36, the convex protrusion 46 may be formed to be horizontal with the upper supporting protrusion 40 without being curved.

In the locking structure of the airtight container according to the embodiment, the lockable lid 32 is disposed to cover the opening portion 16 of the container body 34, and the locking wing 38 is rotated in a locking direction so that the flange 36 of the container body 34 is engaged between the upper and lower supporting protrusions 40 and 42 of the locking wing 38, thereby enabling locking of the airtight container.

More specifically, in the locking procedure, while the convex protrusion 46 meets the upper surface of the flange 36 and moves toward the concave groove 44, the upper supporting protrusion 40 is lifted and the interval D is slightly increased as compared with the initial state.

In addition, while the convex protrusion 46 moves toward the concave groove 44, the flange 36 is naturally engaged between the upper and lower supporting protrusions 40 and 42, so that the convex protrusion 46 meets the concave groove 44.

As described above, when the convex protrusion 46 meets the concave groove 44, due to the restoring force of the upper supporting protrusion 40 which is lifted, the convex protrusion 46 comes in contact with the concave groove 44 to be accommodated, and the arc-shaped surfaces are in contact to be engaged with each other. Specifically, in the engaged state where the upper and lower supporting protrusions 40 and 42 grasp the upper and lower surfaces of the flange 36, respectively, due to complicated effects such as the grasping force exerted to press the flange 36 by the convex protrusion 46 and engagement between the convex protrusion 46 and the concave groove 44, the lockable lid 32 and the container body 34 can be maintained in a tightly locked state or tightly engaged state.

Both of the convex protrusion 46 and the concave groove 44 have arc-shaped curved surfaces. Accordingly, when the locking wing 38 is rotated outward in the engaged state, the convex protrusion 46 can be smoothly separated from the convex groove 44.

In addition, after the convex protrusion 46 is slightly misaligned from the concave groove 44, the sliding action proceeds more smoothly. Accordingly, the locking wing 38 can be easily released from the flange 36 of the container body 34 with less force.

As described above, since locking and releasing can be easily performed with a small force, force is not exerted excessively on the convex protrusion 46 and the flange 36 during the locking and releasing. Therefore, problems such as deformation or breakage of the convex protrusion 46 and the flange 36 do not occur.

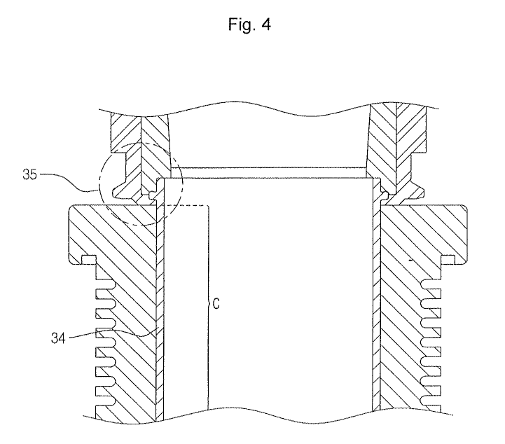

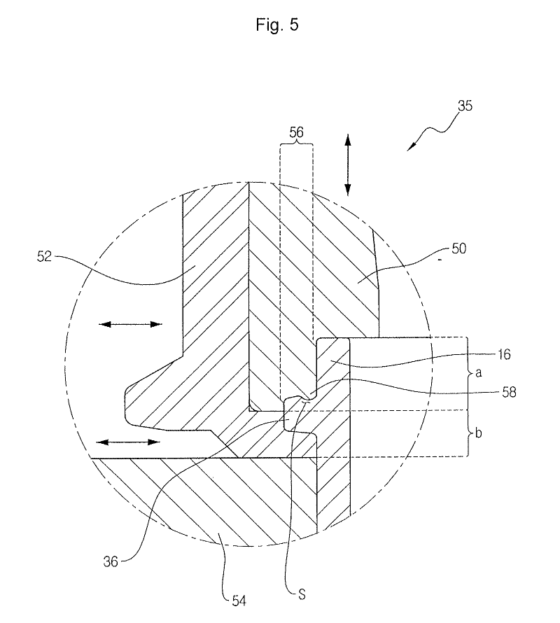

FIG. 4 is a sectional view illustrating a mold according to an embodiment for press-forming the container body 34, particularly, the container body 34 made of a glass material. FIG. 5 is an enlarged view illustrating a portion denoted by a reference numeral 48 of FIG. 4. A description of the container body 34 is provided with reference to FIGS. 2 and 3.

Here, press-forming the container body 34 that is to be shaped in the embodiment is performed in the state where the concave groove 44 is not formed at the flange 36 yet and the shape of container body 34 is not exactly formed as a semi-finished product. In addition, the container body 34 is sectioned to be press-formed.

Specifically, the mold includes a first mold 50 which is formed vertically to press-form a flange upper area a in addition to the opening portion 16, a second mold 52 which is disposed outside the first mold 50 to press-form a flange lower area b, and a third mold 54 which is disposed under the second mold 52 to press-form a container body lower area c below the flange 36.

As described above, when the container body 34 as the semi-finished product is transferred to a molding apparatus, the first mold 50 which reciprocates vertically comes in contact with the upper portion 16 and the flange upper area a, and the second and third molds 52 and 54 which move horizontally then come in contact with the flange lower area b and the container body lower area c, respectively, to exert pressure together, thereby performing press-forming.

Here, a convex protrusion 58 protruding downward is formed at a press-formed portion 56 of the first mold 50 corresponding to a spot S where the opening portion 16 and the root of the flange 36 meet each other, so that the concave groove 44 formed by the convex protrusion 58 during the press-forming can be formed at the upper surface of the flange 36.

While the exemplary embodiments have been shown and described, it will be understood by those skilled in the art that various changes in form and details may be made thereto without departing from the spirit and scope of this disclosure as defined by the appended claims.

In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure such as the aforementioned containers, vessels, jars, cups, and the like, but that this disclosure will include all embodiments falling within the scope of the appended claims.

1. An airtight container comprising:
a container body having an opening portion and a flange formed along an outer circumference of the opening portion; and
a lockable lid that is disposed to cover the opening portion of the container body and that has a locking wing at an edge,
wherein the locking wing further comprises upper and lower supporting protrusions disposed on an inner surface of the locking wing at an interval that permits engagement of the flange between the upper and lower supporting protrusions.

2. The airtight container according to claim 1,
further comprising a convex protrusion that is formed at an end portion of the upper supporting protrusion to engage an upper surface of the upper supporting protrusion, and
wherein the convex protrusion has a surface that is curved toward the lower supporting protrusion.

3. The airtight container according to claim 2,
wherein the convex protrusion further comprises an outer curved surface and
wherein the flange further comprises an arc-shaped concave groove at an upper surface of the flange to be in contact with and to be engaged with the outer curved surface of the convex protrusion.

4. A mold for press-forming an airtight container comprising:
a first mold that is formed vertically to press-form a flange having an upper area and an opening portion;
a second mold that is disposed outside the first mold to press-form a lower area of the flange; and
a third mold that is disposed under the second mold to press-form a container body lower area below the flange,
wherein the first mold further comprises a convex protrusion protruding downward at a press-formed portion of the first mold corresponding to a spot where the flange opening portion and a root of the flange meet each other, and
wherein the flange upper area further comprises a concave groove press-formed by the convex protrusion during the press-forming.
